(19) United States
(12) Patent Application Publication
(10) Pub. No.: US 2026/0242018 A1
(43) Pub. Date: Aug. 20, 2026

(54) DRIVE ARRANGEMENT FOR A VEHICLE

(71) Applicant: Oshkosh Corporation, Oshkosh, WI (US)

(72) Inventors: Devin Rosencrance, Oshkosh, WI (US); Tyler Walsh, Oshkosh, WI (US); Samuel Nessibu, Oshkosh, WI (US)

(73) Assignee: Oshkosh Corporation, Oshkosh, WI (US)

(21) Appl. No.: 19/086,653

(22) Filed: Mar. 21, 2025

Related U.S. Application Data
(60) Provisional application No. 63/643,608, filed on May 7, 2024.
(60) Provisional application No. 63/643,653, filed on May 7, 2024.
(60) Provisional application No. 63/643,541, filed on May 7, 2024.
(60) Provisional application No. 63/643,528, filed on May 7, 2024.
(60) Provisional application No. 63/643,627, filed on May 7, 2024.
(60) Provisional application No. 63/643,723, filed on May 7, 2024.
(60) Provisional application No. 63/643,788, filed on May 7, 2024.
(60) Provisional application No. 63/643,631, filed on May 7, 2024.
(60) Provisional application No. 63/643,617, filed on May 7, 2024.
(60) Provisional application No. 63/713,023, filed on Oct. 28, 2024.
(60) Provisional application No. 63/712,662, filed on Oct. 28, 2024.
(60) Provisional application No. 63/712,621, filed on Oct. 28, 2024.
(60) Provisional application No. 63/712,647, filed on Oct. 28, 2024.
(60) Provisional application No. 63/712,602, filed on Oct. 28, 2024.
(60) Provisional application No. 63/741,710, filed on Jan. 3, 2025.
(60) Provisional application No. 63/741,768, filed on Jan. 3, 2025.
(60) Provisional application No. 63/775,273, filed on Mar. 20, 2025.

(51) Int. Cl. B62D 65/02; B62D 65/18

(52) U.S. Cl. CPC B62D 65/022; B62D 65/18

(57) ABSTRACT

A vehicle includes a frame, a subframe pivotably coupled to the frame, a first wheel and a second wheel coupled to the subframe, and a drive motor coupled to the subframe and configured to drive the first wheel to propel the vehicle. The subframe is configured to pivot relative to the frame to maintain contact of the first wheel and the second wheel with a ground surface.

### CROSS-REFERENCE TO RELATED PATENT APPLICATIONS

This application claims the benefit of and priority to (a) U.S. Provisional Patent Application 63/643,653, filed on May 7, 2024, (b) U.S. Provisional Patent Application 63/643,631, filed on May 7, 2024, (c) U.S. Provisional Patent Application 63/643,541, filed on May 7, 2024, (d) U.S. Provisional Patent Application 63/643,627, filed on May 7, 2024, (e) U.S. Provisional Patent Application 63/643,723, filed on May 7, 2024, (f) U.S. Provisional Patent Application 63/643,528, filed on May 7, 2024, (g) U.S. Provisional Patent Application 63/643,788, filed on May 7, 2024, (h) U.S. Provisional Patent Application 63/643,617, filed on May 7, 2024, (i) U.S. Provisional Patent Application 63/643,608, filed on May 7, 2024, (j) U.S. Provisional Patent Application 63/712,602, filed on Oct. 28, 2024, (k) U.S. Provisional Patent Application 63/712,621, filed on Oct. 28, 2024, (l) U.S. Provisional Patent Application 63/713,023, filed on Oct. 28, 2024, (m) U.S. Provisional Patent Application 63/712,662, filed on Oct. 28, 2024, (n) U.S. Provisional Patent Application 63/712,647, filed on Oct. 28, 2024, (o) U.S. Provisional Patent Application 63/741,768, filed on Jan. 3, 2025, (p) U.S. Provisional Patent Application 63/741,710, filed on Jan. 3, 2025, and (q) U.S. Provisional Patent Application 63/775,273, filed on Mar. 20, 2025, each of which is incorporated herein by reference in its entirety.

### BACKGROUND

The present disclosure relates generally to vehicles. More specifically, the present disclosure relates to vehicles utilized to transport material.

In a manufacturing environment, products are moved along a manufacturing line as various assembly processes are performed. In some such embodiments, the products are supported and/or propelled by vehicles. These vehicles may have varying ways of supporting the products and may incorporate varying levels of autonomy.

### SUMMARY

In an exemplary embodiment a vehicle includes: a frame; a subframe pivotably coupled to the frame; a first wheel and a second wheel coupled to the subframe; and a drive motor coupled to the subframe and configured to drive the first wheel to propel the vehicle, wherein the subframe is configured to pivot relative to the frame to maintain contact of the first wheel and the second wheel with a ground surface.

In another exemplary embodiment, a drive arrangement for a vehicle includes: a first drive module including: a first subframe pivotably coupled to a frame; a first caster coupled to the first subframe; a first drive wheel rotatably coupled to the first subframe; and a first drive motor coupled to the first subframe and configured to drive the first drive wheel; and a second drive module including: a second subframe pivotably coupled to the frame; a second caster coupled to the second subframe; a second drive wheel rotatably coupled to the second subframe; and a second drive motor coupled to the second subframe and configured to drive the second drive wheel.

In another exemplary embodiment, a vehicle includes: a frame; a first drive module including: a first subframe pivotably coupled to the frame; a first caster coupled to the first subframe; a first drive wheel rotatably coupled to the first subframe; a first biasing element coupled to the first subframe and configured to bias the first subframe to rotate about a first lateral axis to direct the first drive wheel toward a ground surface; and a first drive motor coupled to the first subframe and configured to drive the first drive wheel; and a second drive module including: a second subframe pivotably coupled to the frame; a second caster coupled to the second subframe; a second drive wheel rotatably coupled to the second subframe; a second biasing element coupled to the second subframe and configured to bias the second subframe to rotate about a second lateral axis to direct the second drive wheel toward the ground surface; and a second drive motor coupled to the second subframe and configured to drive the second drive wheel, wherein the first drive wheel and the second drive wheel are configured to rotate independently in opposite directions to turn the frame about a substantially vertical axis extending within an outer perimeter defined by the frame.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a vehicle, according to an exemplary embodiment.

FIG. 2 is a top view of the vehicle of FIG. 1.

FIG. 3 is a perspective view of the vehicle of FIG. 1 equipped with a lifting implement, according to an exemplary embodiment.

FIG. 4 is a perspective view of the vehicle of FIG. 3 and another vehicle cooperating to support a telehandler, according to an exemplary embodiment.

FIG. 5 is a perspective view of the vehicle of FIG. 1 equipped with a cart implement, according to an exemplary embodiment.

FIG. 6 is a perspective view of the vehicle of FIG. 3 interfacing with a cart supporting a boom assembly, according to an exemplary embodiment.

FIG. 7 is a block diagram of a control system for the vehicle of FIG. 1.

FIG. 8 is a top view of a production system including the vehicle of FIG. 1, according to an exemplary embodiment.

FIG. 9 is a perspective view of a drive arrangement, according to an exemplary embodiment;

FIG. 10 is a perspective view of the drive arrangement of FIG. 9;

FIG. 11 is a perspective view of a subframe of a drive arrangement, according to an exemplary embodiment.

FIG. 12 is a perspective view of the subframe of FIG. 11;

FIG. 13 is a diagram of a drive arrangement on a flat surface, according to an exemplary embodiment.

FIG. 14 is a diagram of a drive arrangement on an uneven surface, according to an exemplary embodiment.

FIG. 15 is a diagram of a drive arrangement on an uneven surface, according to an exemplary embodiment.

FIG. 16 is a perspective view of a subframe of a drive arrangement, according to an exemplary embodiment.

FIG. 17. is a bottom perspective view of a portion of the drive arrangement of FIG. 10, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a vehicle may include a drive arrangement to maneuver the vehicle about a ground surface and maintain engagement of the vehicle with the ground surface. More specifically, the drive arrangement may include one or more subframes coupled to a frame of the vehicle. The one or more subframes each include a drive wheel driven by a motor and a caster wheel. The one or more subframes may pivot to maintain engagement of the drive wheel and the caster wheel with the ground surface. The drive arrangement may include one or more caster wheels, which also maintain contact with the ground surface, to distribute the weight of the vehicle and facilitate steering of the vehicle as the vehicle maneuvers the ground surface.

### Overall Vehicle

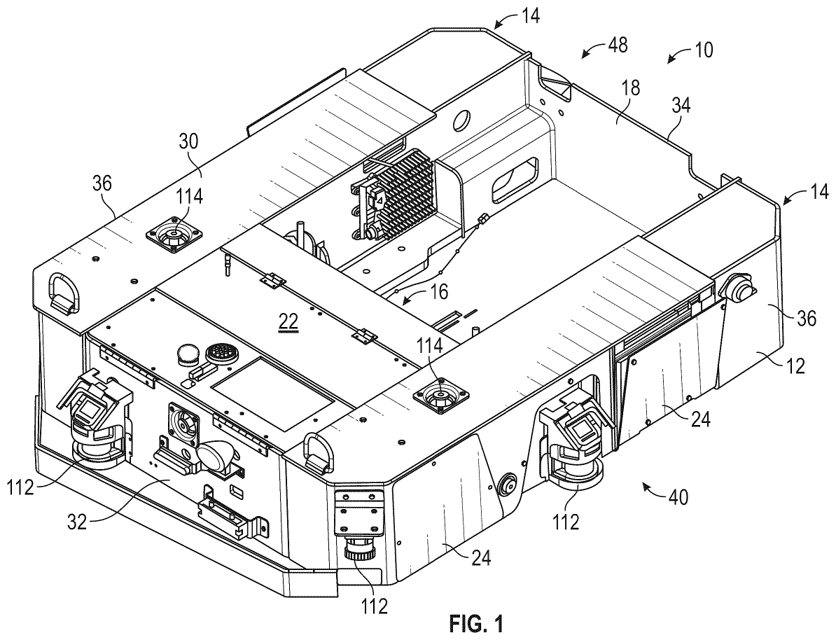

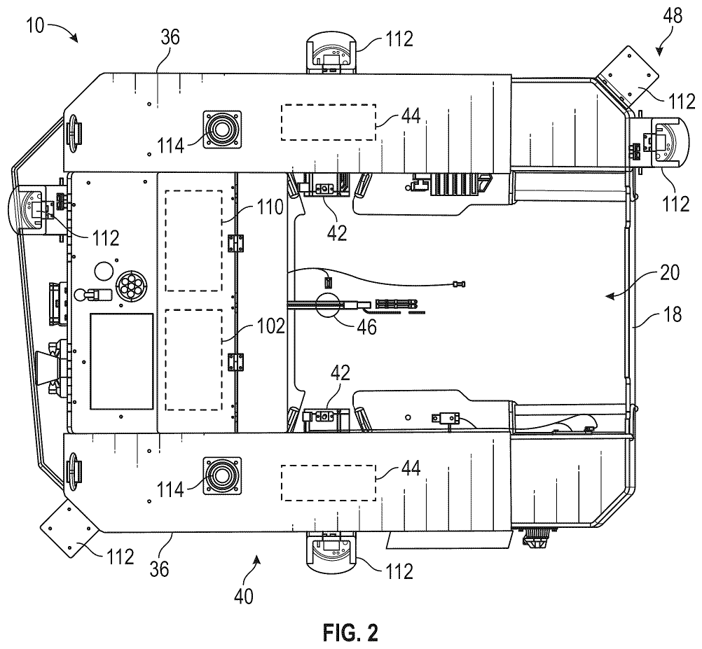

Referring to FIGS. 1 and 2, a machine, vehicle, trolley, transport, hauler, mule, or tug, is shown as vehicle 10 according to an exemplary embodiment. The vehicle 10 may be configured to support, push, pull, turn, or otherwise facilitate movement of a product or components of a product throughout a manufacturing environment. By way of example, the vehicle 10 may move a product (e.g., another vehicle or machine) along a manufacturing line as the product is assembled. The vehicle 10 may move the product between stations where different assembly operations are performed. Additionally or alternatively, the vehicle 10 may be used to move parts or subassemblies (e.g., booms, engines, tires, etc.) throughout the manufacturing environment (e.g., to the product, to a storage area, etc.).

The vehicle 10 may be manually controlled, partially autonomous, or fully autonomous. In some embodiments, the vehicle 10 is configured as a semi-automated guided vehicle (SGV). When configured as an SGV, the vehicle 10 may be manually operated by an operator (e.g., through a wireless or tethered user interface). By way of example, the operator may manually control the steering of the vehicle 10. In some embodiments, the vehicle 10 is configured as an automated guided vehicle (AGV). When configured as an AGV, the vehicle 10 may navigate along a predefined route (e.g., using a magnetic strip or other fixed navigation element). If the vehicle 10 configured as an AGV encounters an obstacle, the vehicle 10 may rely on manual intervention from an operator (e.g., through a user interface) to correct course and navigate around the obstacle. In some embodiments, the vehicle 10 is configured as an autonomous mobile robot (AMR). When configured as an AMR, the vehicle 10 may autonomously navigate through an area without requiring a predefined path. The vehicle 10 configured as an AMR may avoid obstacles without manual intervention by an operator.

The vehicle 10 includes a chassis, shown as frame 12, that supports the other components of the vehicle 10. In some embodiments, the frame 12 defines an enclosure that contains one or more components of the vehicle 10. The frame 12 includes a pair of side portions, shown as drive modules 14, a central portion, shown as controls enclosure 16, and a lateral member, shown as back plate 18. The drive modules 14 each extend longitudinally along the vehicle 10 and are laterally offset from one another. The controls enclosure 16 and the back plate 18 each extend laterally between the drive modules 14, fixedly coupling the drive modules 14 to one another. The controls enclosure 16 and the back plate 18 are longitudinally offset from one another, such that a recess or passage, shown as implement recess 20, is defined between the controls enclosure 16, the back plate 18, and the drive modules 14.

The drive modules 14 may contain components that facilitate propulsion of the vehicle (e.g., the drivetrain 40). The drive modules 14 may include one or more removable or repositionable panels, shown as drive module doors 24, that facilitate access to components within the drive modules 14 from outside of the vehicle 10. The controls enclosure 16 may contain components that facilitate powering or control over the vehicle (e.g., the controller 102, the batteries 110). The controls enclosure 16 includes a removable or repositionable panel, shown as controls enclosure door 22, that facilitates access to components within the controls enclosure 16 from outside of the vehicle 10. In other embodiments, the vehicle 10 includes a separate housing, body, or enclosure that is coupled to the frame 12 and contains one or more components of the vehicle.

The frame 12 defines a top surface 30, a front surface 32, a rear surface 34, and a pair of side surfaces 36 of the vehicle 10. The top surface 30 extends substantially horizontally across the drive modules 14 and the controls enclosure 16. A distance from the top surface 30 to the ground beneath the vehicle 10 may define a height of the vehicle 10. The front surface 32 is positioned at a front end portion of the frame 12 and extends substantially vertically and laterally across the drive modules 14 and the controls enclosure 16. The rear surface 34 is positioned at a rear end portion of the frame 12 and extends substantially vertically and laterally across the drive modules 14 and the back plate 18. The side surfaces 36 each extend longitudinally along one of the drive modules 14, between the front surface 32 and the rear surface 34.

The vehicle 10 includes a drive system or driveline, shown as drivetrain 40, that is configured to propel and steer the vehicle 10. The driveline includes a pair of actuators or motors (e.g., hydraulic motors, pneumatic motors, electric motors, etc.), shown as drive motors 42. In some embodiments, the drive motors 42 are electric motors powered by an electrical energy source (e.g., the batteries 110, energy from a power grid external to the vehicle 10, etc.). The drive motors 42 are each configured to provide rotational mechanical energy to drive rotation of one or more tractive elements 44 (e.g., wheel and tire assemblies). In some embodiments, the drive motors 42 drive the left and right sides of the drivetrain 40 independently, facilitating skid steer operation of the vehicle 10. By way of example, the tractive elements 44 may be driven at the same speed and in the same direction to travel straight. By way of another example, the tractive elements 44 may be driven at different directions and/or at different speeds to turn the vehicle 10. By driving the tractive elements 44 at the same speed and in opposite directions, the drivetrain 40 may rotate the vehicle 10 about a substantially vertical axis, shown as central axis 46, that is substantially centered relative to the frame 12. Rotation of the vehicle 10 about the central axis 46 may facilitate reorienting the vehicle 10 without changing position (i.e., turning in place).

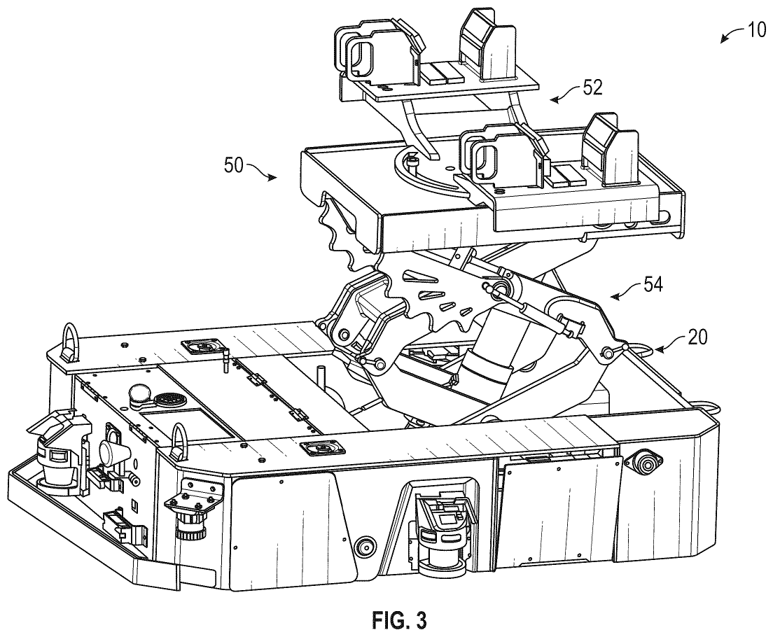

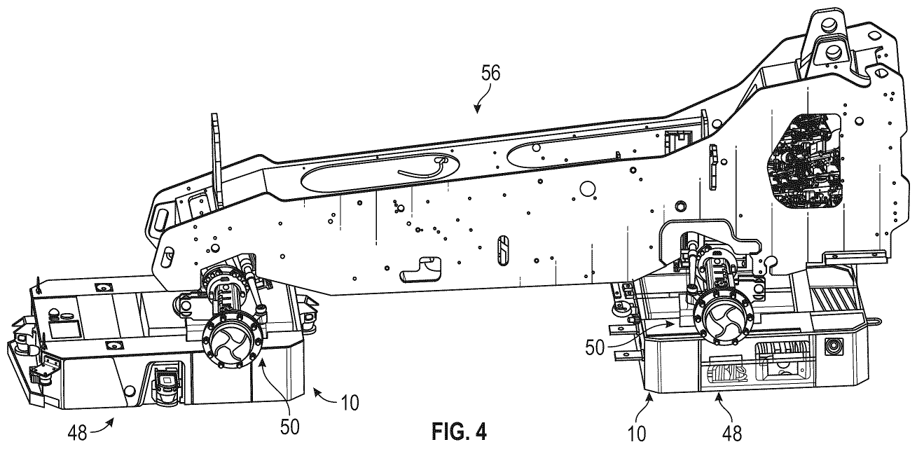

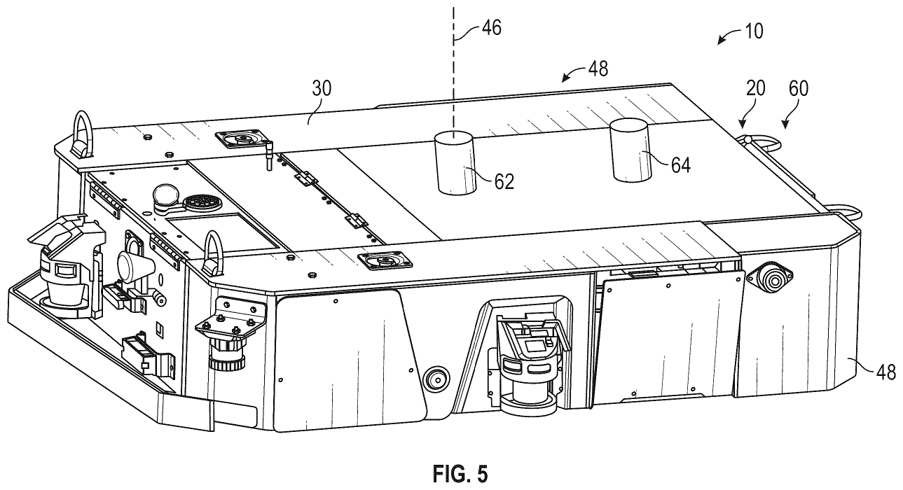

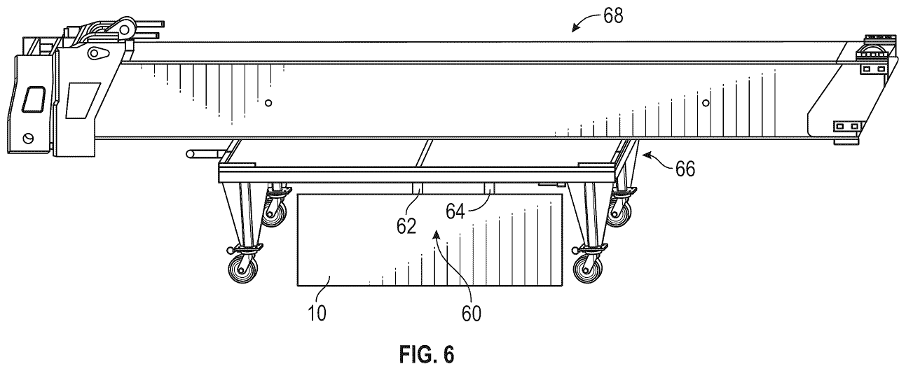

The frame 12, the drivetrain 40, and various other components coupled to the frame 12 form a base portion of the vehicle 10, shown as base assembly 48. To facilitate moving a product, the vehicle 10 may include an implement that that selectively couples the base assembly 48 to a product. FIGS. 3 and 4 illustrate a first implement, shown as lifting implement 50, and FIGS. 5 and 6 illustrate a second implement, shown as cart implement 60. Each implement may be received within the implement recess 20 and fixedly coupled to the frame 12. In some embodiments, the implement is removable from the implement recess 20 to facilitate interchanging with another type of implement. By way of example, the lifting implement 50 may be removed and replaced with the cart implement 60. In other embodiments, the implement is permanently installed on the vehicle.

Referring to FIGS. 3 and 4, the lifting implement 50 includes a product interface, shown as cradle 52, and a lift device or lifting assembly, shown as lift assembly 54. The cradle 52 is configured to receive and directly support a product, shown as telehandler 56. By way of example, the cradle 52 may receive an axle assembly of the telehandler 56. The lift assembly 54 couples the cradle 52 to the frame 12. The lift assembly 54 may be extended to raise the cradle 52 or retracted to lower the cradle 52. Accordingly, the lift assembly 54 may be used to raise or lower the telehandler 56.

Certain large products, such as the telehandler 56, may be difficult to support with only a single vehicle 10. To facilitate steering the product and spreading out the weight of the product, multiple vehicles 10 may be utilized. In the example shown in FIG. 4, a front axle of the telehandler 56 is supported by one vehicle 10, and a rear axle of the telehandler 56 is supported by another vehicle 10. In some embodiments, the vehicles 10 are independently operable. In other embodiments, operation of one vehicle 10 is dependent upon the other vehicle 10. By way of example, a first vehicle 10 may supply electrical energy to, propel, and/or control operation of the other vehicle 10.

Referring to FIGS. 5 and 6, the cart implement 60 includes a pair of protruding interface elements (e.g., pins), extending above the top surface 30. Specifically, the cart implement 60 includes a central pin, shown as driving pin 62, and an offset pin, shown as turning pin 64, that can each be selectively raised and lowered by an actuator of the cart implement 60. The driving pin 62 is centered about the central axis 46, and the turning pin 64 is offset from the central axis 46. The driving pin 62 and the turning pin 64 are positioned to a mobile platform, shown as cart 66, that supports a product subassembly, shown as boom assembly 68.

When extended, the driving pin 62 and the turning pin 64 each engage the cart 66 to limit movement of the cart 66 relative to the base assembly 48. When both the driving pin 62 and the turning pin 64 engage the cart 66, the cart 66 may be fixed to the base assembly 48. When only the driving pin 62 engages the cart 66, the base assembly 48 may rotate freely about the central axis 46 relative to the cart 66, but movement of the vehicle 10 in a particular direction may cause movement of the cart 66 in that same direction. When the driving pin 62 and the turning pin 64 are both retracted away from the cart 66, the vehicle 10 may move freely relative to the cart 66.

The cart 66 may be equipped with casters or slides to facilitate free movement of the cart 66 along the ground. In some embodiments, the cart 66 supports some or all of the weight of the boom assembly 68. The driving pin 62 and the turning pin 64 may generally push horizontally on the cart 66, such that there may be little or no transmission of vertical forces between the cart implement 60 and the cart 66. Accordingly, the vertical load on the vehicle 10 may be minimized while still permitting the vehicle 10 move the cart 66 and the boom assembly 68 throughout the environment as desired. This reduction in load may reduce the overall cost of the vehicle 10.

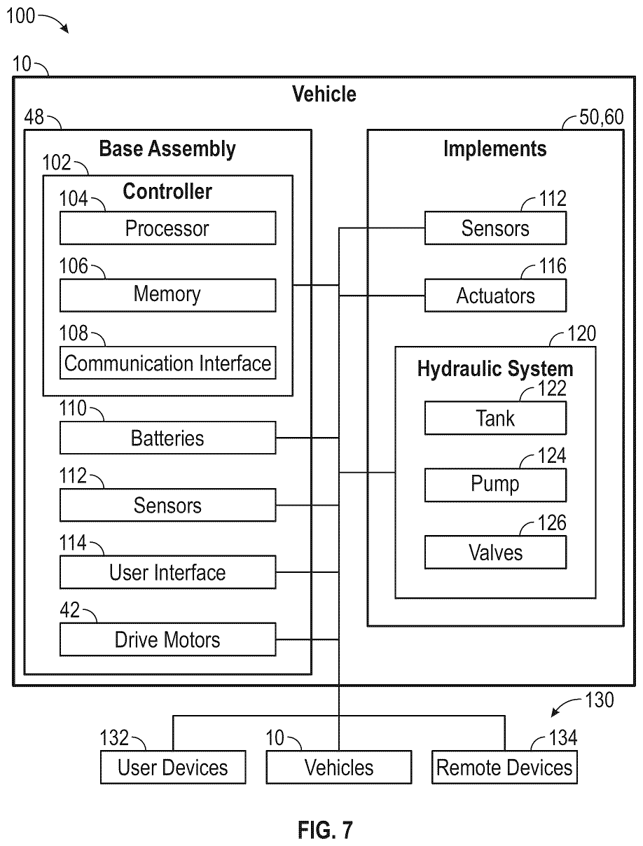

Referring to FIG. 7, the vehicle 10 and a control system 100 for the vehicle 10 are shown according to an exemplary embodiment. The control system 100 may facilitate operation of the vehicle 10 and/or other devices of a production environment. Although certain components are shown as being included in the base assembly 48 and/or the implements 50 and 60, it should be understood that any component may be positioned in the base assembly 48, the lifting implement 50, or the cart implement 60 or duplicated across multiple thereof.

The vehicle 10 includes a controller 102 that controls operation of the vehicle 10. The controller 102 includes a processing circuit, shown as processor 104, and a memory device, shown as memory 106. The memory 106 may contain one or more instruction that, when executed by the processor 104, cause the processor to perform the various functions described herein.

The controller 102 further includes a communication interface 108 (e.g., a communication circuit, a network interface, etc.) that facilitates communication with (e.g., to and from) other components of the vehicle 10 and/or the control system 100. The communication interface 108 may facilitate wired communication (e.g., through CAN, Ethernet, communication of power, etc.). Additionally or alternatively, the communication interface 108 may facilitate wireless communication (e.g., through Bluetooth, Wi-Fi, radio transmission, inductive transmission of energy, etc.).

The base assembly 48 includes one or more energy storage devices, shown as batteries 110. The batteries 110 store energy (e.g., as chemical energy). The batteries 110 may deliver electrical energy to other components of the vehicle 10 to power the vehicle 10. The batteries 110 may be charged by an outside source of energy (e.g., an electrical grid, a wireless charging interface, etc.). In other embodiments, the base assembly 48 includes a different type of energy storage device (e.g., a fuel tank for an internal combustion engine of a generator, a fuel cell, etc.).

The base assembly 48, the lifting implement 50, and the cart implement 60 may each include one or more sensors 112 operatively coupled to the controller 102. The sensors 112 may provide sensor data describing the current status of the vehicle 10 and/or the surrounding environment. By way of example, the sensors 112 may include mapping or imaging sensors (e.g., LIDAR sensors, light curtains, cameras, ultrasonic sensors, etc.). By way of example, the sensors 112 may include position sensors (e.g., GPS, potentiometers, encoders, etc.). By way of example, the sensors 112 may include orientation or acceleration sensors (e.g., accelerometers, gyroscopic sensors, inertial measurement units, compasses, etc.). By way of example, the sensors 112 may include pressure sensors, flowmeters, buttons, or other types of sensors.

The base assembly 48 may include one or more operator interface elements (e.g., input devices, output devices, etc.), shown as user interface 114. The user interface 114 may include output devices that provide information to one or more users. By way of example, the user interface 114 may include displays, speakers, lights, haptic feedback (e.g., vibrators, etc.), or other output devices. The user interface 114 may include input devices that receive information (e.g., commands) from one or more users. By way of example, the user interface 114 may include buttons, switches, knobs, touchscreens, microphones, or other input devices.

The lifting implement 50 and/or the cart implement 60 may include one or more actuators 116 that facilitate controlled movement (e.g., movement of the lifting implement 50 or the cart implement 60). The actuators 116 may include linear actuators (e.g., electric linear actuators, hydraulic cylinders, etc.), motors (e.g., electric motors, hydraulic motors, etc.), or other types of actuators. The actuators 116 may be electrically-powered, hydraulically-powered, or otherwise powered.

The lifting implement 50 and/or the cart implement 60 may include a hydraulic system 120. They hydraulic system 120 may supply pressurized hydraulic fluid (e.g., hydraulic oil) to facilitate operation of other components of the vehicle 10. By way of example, the hydraulic system 120 may supply pressurized hydraulic fluid to an actuator 116. In some embodiments, the hydraulic system 120 forms a self-contained hydraulic loop with one or more actuators 116.

The hydraulic system 120 includes a low-pressure reservoir, shown as tank 122, that stores a volume of hydraulic fluid at a low pressure. A pump 124 receives electrical energy from the batteries 110, draws hydraulic fluid from the tank 122, and supplies a flow of pressurized hydraulic fluid. One or more valves 126 (e.g., solenoid valves, directional control valves, etc.) control the flow of the hydraulic fluid from the pump 124. By way of example, the valves 126 may control the flow rate, direction, and destination of hydraulic fluid flowing throughout the hydraulic system 120. The controller 102 may control operation of the actuators 116 by controlling the valves 126.

The control system 100 further includes additional devices in communication with the vehicle 10. The devices may communicate with the vehicle 10 directly or through a network 130 (e.g., a local area network, a wide area network, the Internet, etc.). The network 130 may utilize wireless and/or wired communication. In some embodiments, the network 130 is a mesh network formed between multiple devices of the control system 100 (e.g., permitting indirect communication between two devices through a third device).

The control system 100 may include multiple vehicles 10. A vehicle 10 may communicate with other vehicles 10 to share information and facilitate operation. By way of example, a vehicle 10 may provide commands to another vehicle 10 to coordinate transportation of a large item that is carried by both of the vehicles 10. By way of another example, a vehicle 10 may provide its location to another vehicle 10 to facilitate path generation and avoid collisions.

The control system 100 may include one or more user devices 132 (e.g., smartphones, tablets, laptops, desktop computers, etc.). The user devices 132 may facilitate a user monitoring and/or controlling operation of the vehicles 10. By way of example, the user devices 132 may indicate statuses of the vehicles 10 (e.g., positions, whether maintenance is needed, if any errors are occurring, what task a vehicle 10 is assigned, etc.). By way of example, the user devices 132 may permit a user to command a vehicle 10 to travel to a different place or to assign a vehicle 10 to a particular production line.

The control system may include one or more remote devices 134 (e.g., servers). In some embodiments, a remote device 134 functions as a production manager that controls various operations throughout a manufacturing environment. The production manager may receive requests for production of certain equipment (e.g., fifteen telehandlers are requested for production by Apr. 12, 2025, etc.). The production manager may monitor the statuses of vehicles 10, personnel, equipment, and raw materials. By way of example, the vehicles 10 may provide sensor data from the sensors 112 to a remote device 134 for storage and/or analysis. Based on the available data, the production manager may generate assignments for vehicles 10, personnel, equipment, and raw materials to meet the production requests. The production manager may adapt to changes in availability (e.g., by reassigning a vehicle 10 to a different task or area in response to a failure of one of the vehicles 10). The assignments for a vehicle 10 may include a path along which the vehicle 10 should travel, a desired configuration of the vehicle 10 (e.g., the type of implement available to the vehicle 10), an amount of time that the vehicle 10 should wait at a given station, etc.

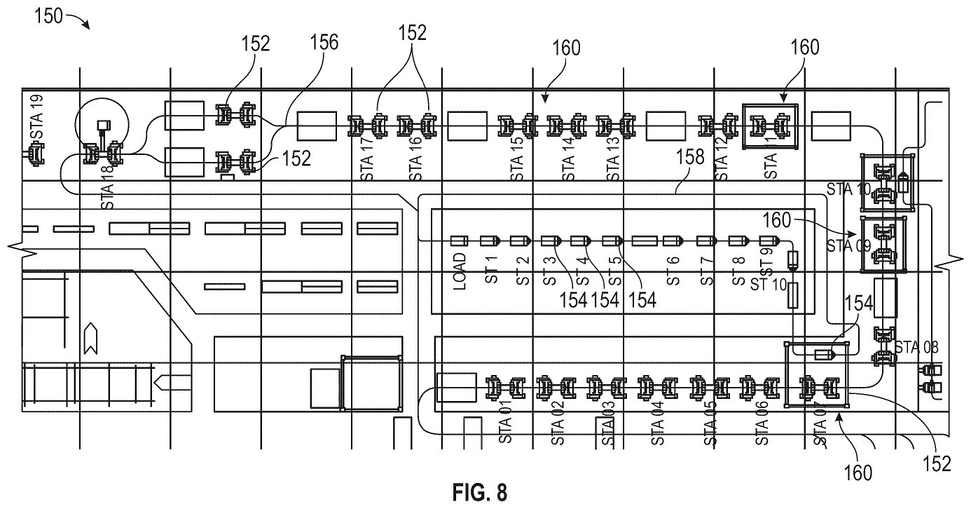

Referring to FIG. 8, a manufacturing environment or production system 150 is shown according to an exemplary embodiment. The production system 150 may include a series of vehicles 10 that move a product 152 and a subassembly 154 through various stages of assembly (e.g., as controlled by a remote device 134). The vehicles 10 move the product 152 along a first path, shown as manufacturing line 156, and the vehicles 10 move the subassembly 154 along a second path, shown as manufacturing line 158. A series of manufacturing or assembly stations, shown as stations 160, are spaced at regular intervals along the manufacturing lines 156 and 158. Each station 160 may be associated with a different manufacturing or assembly process that is performed there. By way of example, there may be stations 160 for attaching components to a product 152, coupling components with hoses or wires, confirming that certain functions are operating properly, etc.

Initially the product 152 and the subassembly 154 move along separate manufacturing lines 156 and 158. After the last station 160 needed to prepare the subassembly 154, the manufacturing line 158 intersects the manufacturing line 156, and the subassembly 154 is attached to the product 152. The product 152 and the subassembly 154 then move together along the manufacturing line 156. This proceeds until the product 152 is fully assembled and removed from the vehicles 10. The vehicles 10 may then return to collect another product that requires assembly, and the manufacturing process is repeated.

In some embodiments, the product 152 assembled by the production system is a vehicle or work machine. By way of example, the product 152 may be a lift device, such as a telehandler, a scissor lift, a boom lift, a vertical lift, an aerial work platform, or another type of lift device. By way of another example, the product 152 may be a fire truck, an aircraft rescue and firefighting apparatus (ARFF) truck, a refuse vehicle, a concrete mixing truck, a tow truck, a broadcast van, a military vehicle, a robot, a truck, a van, a passenger vehicle, or another type of vehicle. In other embodiments, the product 152 is not a vehicle (e.g., is a stationary piece of equipment).

### Drive Arrangement

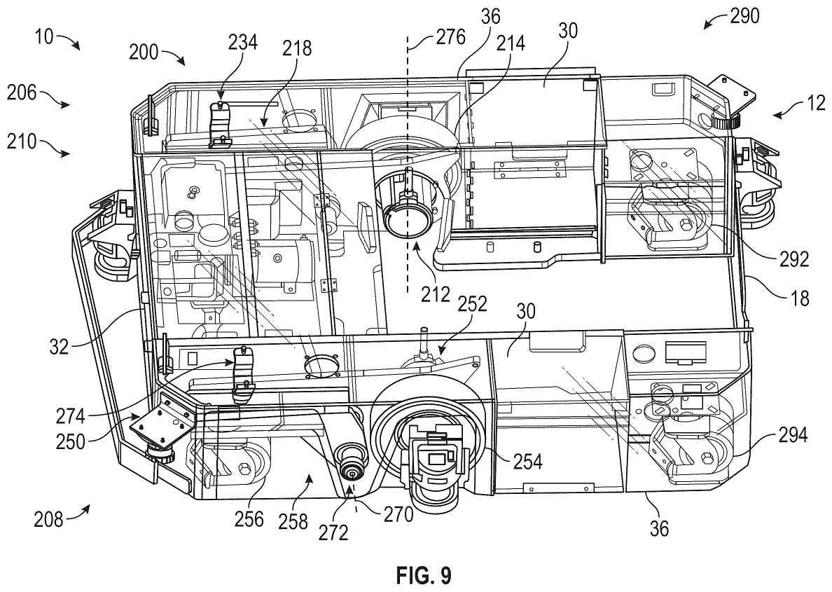

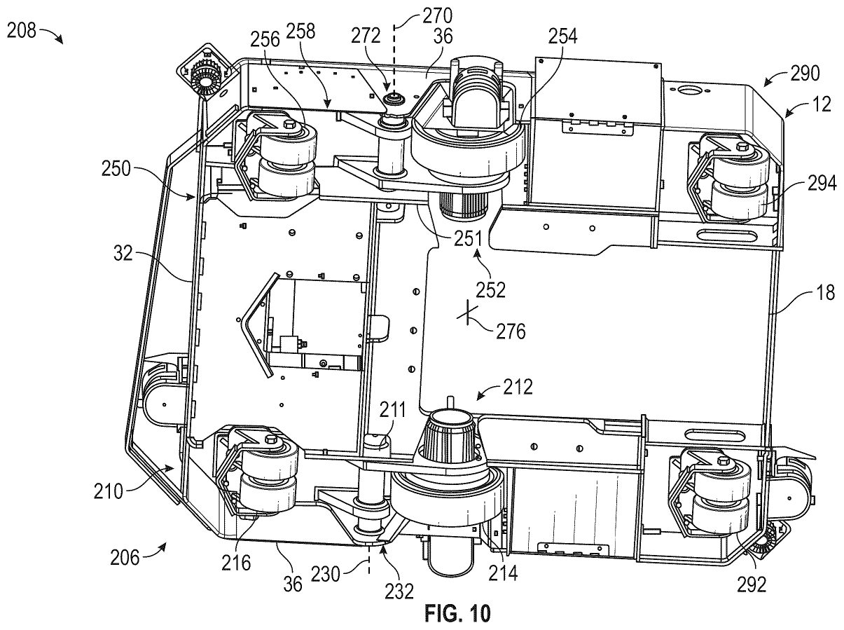

Referring to FIGS. 9 and 10, the drivetrain 40 of the vehicle 10 includes a drive assembly or arrangement 200 configured to maintain traction and engagement of the tractive elements 44 with a ground surface, propelling and steering the vehicle 10. The drive arrangement 200 includes a first drive assembly, shown as first drive module 210, a second drive assembly, shown as second drive module 250, and one or more independent, undriven, or caster wheels, shown as wheels 290, arranged toward the back plate 18 of the frame 12. The first drive module 210 and the second drive module 250 are positioned forward of the wheels 290. It should be noted that the first drive module 210 and the second drive module 210 are substantially similar (e.g., containing similar or identical components) with similar terms and using different reference numerals, unless otherwise described herein.

The first drive module 210 and one of the wheels 290 (e.g., a third caster wheel 292) are positioned along a first lateral or left side 206 of the vehicle 10 and located within the drive module 14 on the left side 206 of the vehicle 10. The first drive module 210 is coupled to the side surface 36 (e.g., on the right side of the vehicle 10) and a first interior wall 211 of the frame 12 (e.g., see FIG. 10). The third caster wheel 292 is configured to rotate, swivel, and/or pivot about a substantially vertical axis. The second drive module 250 and one of the wheels 290 (e.g., a fourth caster wheel 294) are positioned on a right or second lateral side 208 and located within the drive module 14 on the right side 208 of the vehicle 10. The second drive module 250 is coupled to the side surface 36 (e.g., on the left side of the vehicle 10) and a second interior wall 251 of the frame 12 (e.g., see FIG. 10). The fourth caster wheel 294 is configured to rotate, swivel, and/or pivot about a substantially vertical axis.

Referring to FIGS. 9-12, the first drive module 210 includes a first drive motor 212 (e.g., one of the drive motors 42) coupled to a first driven or drive wheel, shown as first drive wheel 214 (e.g., one of the one or more tractive elements 44), a first, undriven, or caster wheel 216, and a first subframe 218. The first drive wheel 214 and the first caster wheel 216 are coupled to the first subframe 218 on opposing ends of the first subframe 218. The first drive motor 212 is configured to drive the first drive wheel 214 to propel the vehicle 10. The first caster wheel 216 is configured to rotate, swivel, and/or pivot about a first substantially vertical axis as the first drive motor 212 drives the first drive wheel 214.

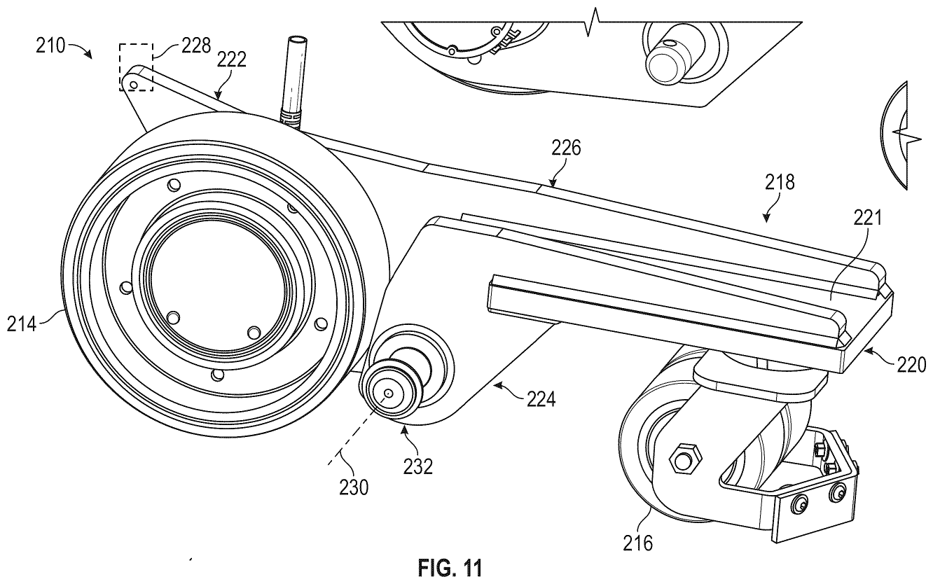

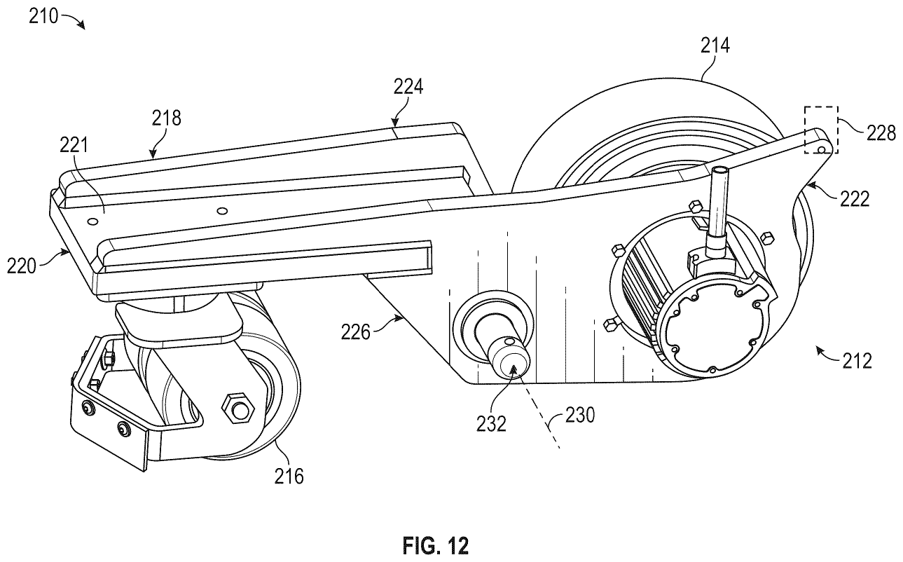

Referring to FIGS. 11 and 12, the first subframe 218 includes a first or front portion 220 disposed toward the front surface 32 of the frame 12, an opposing, second, or rear portion 222, an outer or first lateral portion 224 (e.g., a vertical plate) disposed toward the side surface 36, and an opposing, inner, or second lateral portion 226 (e.g. a vertical plate) from the front portion 220 to the rear portion 222. The front portion 220 includes a middle, extending, or horizontal portion (e.g., a horizontal plate), shown as central wall 221, extending between the outer portion 224 and a portion of the inner portion 226. The central wall 221, the first lateral portion 224, and the second lateral portion 226 may be fixedly coupled to one another (e.g., by welding). The first caster wheel 216 is coupled to the central wall 221 of the front portion 220 of the first subframe 218 by a bracket (e.g., caster wheel bracket or mount), and the first drive wheel 214 is coupled to the outer portion 224 towards the rear portion 222 of the first subframe 218. Specifically, the first drive motor 212 is fixedly coupled to the outer portion 224, and the drive motor 212 rotatably couples the first drive wheel 214 to the outer portion 224.

The first subframe 218 further includes a pivot assembly or link, shown as pivot pin 232 that extends through the outer portion 224 and the inner portion 226 (e.g., through apertures defined by bushings of the outer portion 224 and the inner portion 226) and is positioned between the front portion 220 and the rear portion 222 of the first subframe 218. The pivot pin 232 pivotably couples the first subframe 218 to the side surface 36 and the inner wall 211 of the frame 12. In some embodiments, the pivot pin 232 extends below the central wall 221 of the front portion 220. The pivot pin 232 defines a first lateral axis 230 that extends through the center of the pivot pin 232. The pivot pin 232 is configured to allow the first subframe 218 to pivot relative to the frame 12 about the first lateral axis 230.

In some embodiments, the first subframe 218 further includes a biasing element (e.g., a coil spring, a gas spring, a hydraulic actuator, etc.), shown as a first biasing element 228. The first biasing element 228 is coupled to the rear portion 222 of the first subframe 218 (e.g., see FIGS. 11 and 12). In some embodiments, the first biasing element 228 is configured to bias the first subframe 218 to rotate about the first lateral axis 230. By way of example, the first biasing element 228 may bias the first subframe 218 to direct the first drive wheel 214 downward towards a ground surface (e.g., in a direction away from the top surface 30 of the frame 12, counter-clockwise as shown in FIG. 11, etc.). In some embodiments, a top surface the first subframe 218 engages a bumper 234 coupled to the drive module 14 on the left side 206 of the vehicle 10 (e.g., see FIG. 9) to limit upward travel of the front portion 220. More specifically, the bumper 234 is coupled to the top surface 30 and is configured to engage the central wall 221 of the first subframe 218. By way of example, the bumper 234 defines a distance from the top surface 30 of the frame 12 to limit movement of the first subframe 218 within the distance defined by the bumper 234 as the first subframe 218 pivots relative to the frame 12 and the bumper 234 engages the central wall 221. For example, the bumper 234 may limit rotation of the first drive module 210 when the vehicle 10 is lifted off of the ground (e.g., for maintenance or transport).

Referring to FIGS. 9 and 10, the drive arrangement 200 includes the second drive module 250, which has a substantially similar configuration to the first drive module 210. The second drive module 250 includes a second drive motor 252 (e.g., one of the drive motors 42) coupled to a second driven or drive wheel, shown as second drive wheel 254 (e.g., one of the one or more tractive elements 44), a second, undriven, or caster wheel 256, and a second subframe 258. The second drive wheel 254 and the second caster wheel 256 are coupled to the second subframe 258 on opposing ends of the second subframe 258. The second drive motor 252 is configured to drive the second drive wheel 254 to propel the vehicle 10. The second caster wheel 256 is configured to rotate, swivel, and/or pivot about a second substantially vertical axis as the second drive motor 252 drives the second drive wheel 254.

Similar to the first subframe 218, the second subframe 258 includes a first or front portion disposed toward the front surface 32 of the frame 12, an opposing, second, or rear portion, an outer or first lateral portion disposed toward the side surface 36, and an opposing, inner, or second lateral portion from the front portion to the rear portion. The front portion includes a middle or extending portion, shown as central wall, extending between the outer portion and a portion of the inner portion. The second caster wheel 256 is coupled to the central wall of the front portion of the second subframe 258 by a bracket (e.g., caster wheel bracket or mount), and the second drive wheel 254 is coupled to the outer portion towards the rear portion of the second subframe 258.

The second subframe 258 further includes a pivot assembly or link, shown as pivot pin 272 that extends through the outer portion and the inner portion and is positioned between the front portion and the rear portion of the second subframe 258. The pivot pin 272 pivotably couples the second subframe 258 to the side surface 36 and the inner wall 251 of the frame 12. In some embodiments, the pivot pin 272 extends below the central wall of the front portion of the second subframe 258. The pivot pin 272 defines a second lateral axis 270 that extends through the center of the pivot pin 272. The pivot pin 272 is configured to allow the second subframe 258 to pivot relative to the frame 12 about the second lateral axis 270. In some embodiments, the second subframe 258 further includes a coil spring, a gas spring, a hydraulic actuator, or other biasing element substantially similar or identical to the first biasing element 228 of the first subframe 218. In some embodiments, the second subframe 258 will engage a bumper 274 coupled to the top surface 30 of the frame 12 that is substantially similar or identical to the bumper 234.

The first drive module 210 and the second drive module 250 are configured to operate or function independently from each other to maneuver and/or propel the vehicle 10 over a ground surface (e.g., the first subframe 218 and the second subframe 258 pivot different amounts or degrees, the first drive motor 212 and the second drive motor 252 operate at different speeds and/or directions, one or more of the first caster wheel 216, the second caster wheel 256, the third caster wheel 292, or the fourth caster wheel 294 move in different directions or speeds, etc.). Independent motion of the drive modules 210 and 250 may facilitate operation on inconsistent ground surfaces (e.g., ground surfaces that are not flat).

In some embodiments, the vehicle 10 may traverse the ground surface, which may be uneven, sloped, curved, or include thresholds, bumps, divots, cracks, etc. By way of example, the first drive motor 212 drives the first drive wheel 214, and the first subframe 218 pivots about the first lateral axis 230 to maintain engagement of the first drive wheel 214, the first caster wheel 216, and the third caster wheel 292 with the ground surface. Similarly, the second drive motor 252 drives the second drive wheel 254, and the second subframe 258 pivots the second lateral axis 270 to maintain engagement of the second drive wheel 254, the second caster wheel 256, and the fourth caster wheel 294 with the ground surface. In some embodiments, the first lateral axis 230 and the second lateral axis 270 align or coincide as the first subframe 218 and the second subframe 258 each independently pivot relative to the frame 12 to main engagement of the first drive wheel 214, the first caster wheel 216, the second caster wheel 256, the second drive wheel 254, the third caster wheel 292, or the fourth caster wheel 294 with the ground surface. In other embodiments, as on a sloped ground surface, the first lateral axis 230 and the second lateral axis 270 are unaligned as the first subframe 218 and the second subframe 258 each independently pivot relative to the frame 12 to main engagement of the first drive wheel 214, the first caster wheel 216, the second caster wheel 256, the second drive wheel 254, the third caster wheel 292, or the fourth caster wheel 294 with the ground surface.

In some embodiments, the first drive motor 212 and the second drive motor 252 operate independently from one another to facilitate skid steer operation of the vehicle 10. By way of example, the first drive motor 212 and the second drive motor 252 may drive the first drive wheel 214 and the second drive wheel 254, respectively, at the same speed to drive the vehicle 10 straight. By way of another example, the first drive motor 212 and the second drive motor 252 may drive the first drive wheel 214 and the second drive wheel 254, respectively, at different speeds and/or in different directions (e.g., one drive wheel rotates forward while the other drive rotates backwards) to turn the vehicle 10 about a central or substantially vertical axis 276. In some embodiments, the front surface 32, the rear surface 34, and the pair of side surfaces 36 of the frame 12 define an outer perimeter of the frame 12, within which the central vertical axis 276 extends. In such embodiments, the central vertical axis 276 may shift based on the relative speeds and directions of the first drive motor 212 and the second drive motor 252.

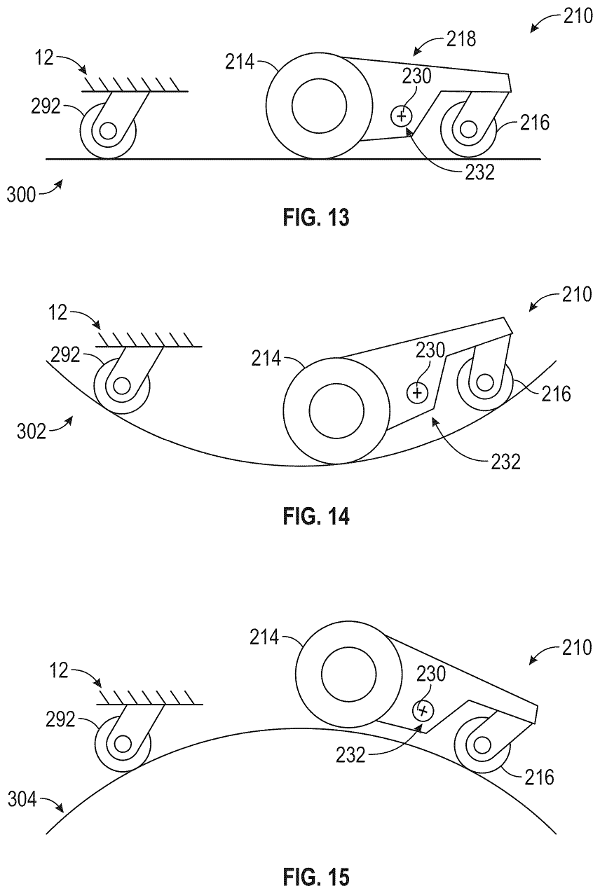

Referring to FIGS. 13-15, the drive arrangement 200 is shown navigating ground surfaces of varying shapes and curvatures, maintaining engagement of the wheels with the ground surface regardless of the shape of the ground surface. The ground surface may be a flat ground surface 300 (e.g., see FIG. 13), a curved or concave surface 302 (e.g., see FIG. 14), a curved or convex surface 304 (e.g., see FIG. 15), or a combination of one or more of the flat surface 300, the curved surface 302, or the curved surface 304. Although FIGS. 13-15 illustrate the first drive module 210 and the caster wheel 292, the second drive module 250 and the caster wheel 294 may perform similarly (e.g., based on the shape of the ground surface contacted by the drive module 250 and the caster wheel 294). As shown in FIGS. 13-15, the caster wheel 292 and the caster wheel 294 each have a fixed vertical distance from the frame 12 that remains substantially consistent as the vehicle 10 maneuvers the flat surface 300, the curved surface 302, and/or the curved surface 304.

Referring to FIG. 13, the drive arrangement 200 (e.g., the first drive module 210 and the third caster wheel 292) engage the flat surface 300. In the exemplary embodiment, the first drive wheel 214, the first caster wheel 216, and the third caster wheel 292 each engage the flat surface 300 at a corresponding contact point (e.g., the bottom portion of the wheels). The contact point of the first drive wheel 214, the contact point of the first caster wheel 216, and the contact point of the third caster wheel 292 are substantially aligned along a horizontal plane defined by the flat surface 300. The first drive module 210 has a first orientation about the first lateral axis 230 defined by the pivot pin 232 in FIG. 13.

Referring to FIG. 14, the drive arrangement 200 (e.g., the first drive module 210 and the third caster wheel 292) engage the curved surface 302. In the exemplary embodiment, the first drive wheel 214, the first caster wheel 216, and the third caster wheel 292 each engage the curved surface 302 at a corresponding contact point (e.g., the bottom portion of the wheels). The contact point of the first drive wheel 214, the contact point of the first caster wheel 216, and the contact point of the third caster wheel 292 are staggered or offset from one another as the respective contact points engage the curved surface 302. The first drive module 210 is positioned such that the first subframe 218 pivots upward (e.g., relative to the front of the vehicle 10) about the first lateral axis 230 defined by the pivot pin 232 in response to contacting the curved surface 302. By way of example, the caster wheel 216 may contact the curved surface 302 before the drive wheel 214. Due to the offset of the caster wheel 216 from the lateral axis 230, the normal force on the caster wheel 216 applies a torque onto the drive module 210 (e.g., counterclockwise as shown in FIG. 14), causing the drive module 210 to rotate until the drive wheel 214 contacts the curved surface 302. In this position, the contact point of the first drive wheel 214 is lower than the contact point of the first caster wheel 216 and the contact point of the third caster wheel 292. Accordingly, the pivot pin 232 permits the first subframe 218 to pivot and maintain engagement of the first drive wheel 214, the first caster wheel 216, and the third caster wheel 292 with the curved surface 302, improving traction of the first drive wheel 214 and spreading the weight of the vehicle 10 across all of the wheels.

Referring to FIG. 15, the drive arrangement 200 (e.g., the first drive module 210 and the third caster wheel 292) engage the curved surface 304 at the respective contact points (e.g., the bottom portion of the wheels). The contact point of the first drive wheel 214, the contact point of the first caster wheel 216, and the contact point of the third caster wheel 292 are staggered or offset from one another as the respective contact points engage the curved surface 304. The first drive module 210 is positioned such that the first subframe 218 pivots downward (e.g., relative to the front of the vehicle 10) about the first lateral axis 230 defined by the pivot pin 232 in response to contacting the curved surface 304. By way of example, the caster wheel 216 may contact the curved surface 304 before the drive wheel 214. Due to the offset of the caster wheel 216 from the lateral axis 230, the normal force on the caster wheel 216 applies a torque onto the drive module 210 (e.g., clockwise as shown in FIG. 15), causing the drive module 210 to rotate until the drive wheel 214 contacts the curved surface 304. In this position, the contact point of the first drive wheel 214 is higher than the contact point of the first caster wheel 216 and the contact point of the third caster wheel 292. Accordingly, the pivot pin 232 permits the first subframe 218 to pivot to maintain engagement of the first drive wheel 214, the first caster wheel 216, and the third caster wheel 292 with the curved surface 304, improving traction of the first drive wheel 214 and spreading the weight of the vehicle 10 across all of the wheels.

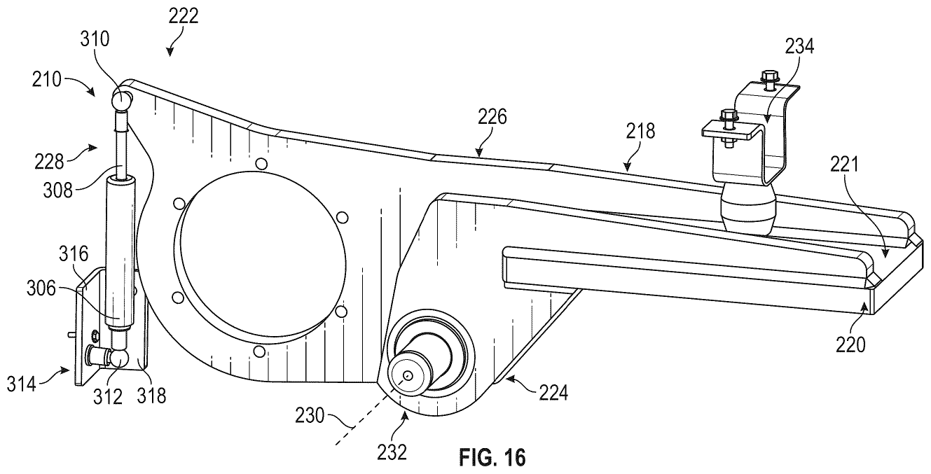

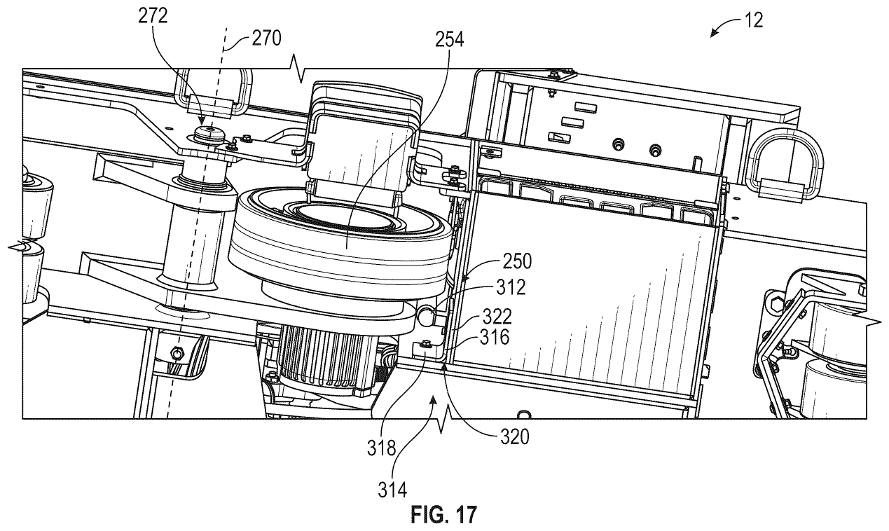

Referring to FIGS. 16 and 17, the first drive module 210 according to another embodiment. The first drive module 210 may be similar to the first drive module 210 of FIGS. 11 and 12 other than otherwise specified. The first biasing element 228 is a gas spring. The first biasing element 228 includes a body 306, a rod 308, a first swivel coupling 310, and a second swivel coupling 312. The rod 308 is received within the body 306, and configured to move in with respect to the body 306, in and out of an end of the body 306. The rod 308 includes compressed gas sealed inside of the rod 308. The first swivel coupling 310 is coupled to a first end of the body 306, and the second swivel coupling 312 is coupled to a second end of the body 306, the second end opposite the first end. Each of the first swivel coupling 310 and the second swivel coupling 312 enable the first biasing element 228 to rotate relative to the frame 12. In the illustrated embodiment, the first swivel coupling 310 and the second swivel coupling 312 are ball studs. The first swivel coupling 310 is coupled to the rear portion 222 of the first subframe 218, and enables the first biasing element 228 it rotate relative to the first subframe 218.

The first drive module 210 includes a bracket 314. The bracket 314 includes a first portion 316 and a second portion 318. The first portion 316 extends substantially perpendicular to the second portion 318. The first portion 316 and the second portion 318 are each configured to couple to a mounting location 320 on the frame 12 (as shown in FIG. 17). The mounting location 320 is located at the first interior wall 211 and a third interior wall 322 adjacent to the first interior wall 211. The second swivel coupling 312 is coupled to the first portion 316 of the bracket 314, and enables the first biasing element 228 to rotate relative to the frame 12.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the production system as shown in the various exemplary embodiments is illustrative only. Additionally, any element disclosed in one embodiment may be incorporated or utilized with any other embodiment disclosed herein. For example, the first drive module 210 of the exemplary embodiment shown in at least FIGS. 11-15 may be incorporated in the second drive module 250 of the exemplary embodiment shown in at least FIGS. 9-10. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A vehicle comprising:
a frame;
a subframe pivotably coupled to the frame;
a first wheel and a second wheel coupled to the subframe; and
a drive motor coupled to the subframe and configured to drive the first wheel to propel the vehicle, wherein the subframe is configured to pivot relative to the frame to maintain contact of the first wheel and the second wheel with a ground surface.

2. The vehicle of claim 1, wherein:
the subframe defines an outer perimeter, a substantially vertical axis extending within the outer perimeter;
the first wheel is a first drive wheel;
the vehicle further includes a second drive wheel; and
rotation of the first drive wheel and the second wheel in opposite directions rotates the frame about the substantially vertical axis.

3. The vehicle of claim 1, wherein a first lateral axis is defined between the first wheel and the second wheel and the subframe is configured to pivot relative to the frame about the first lateral axis.

4. The vehicle of claim 3, further comprising a bumper coupled to the frame, wherein the bumper and the second wheel are forward of the first lateral axis and the bumper is configured to limit upward movement of the second wheel.

5. The vehicle of claim 1, further comprising a third wheel coupled to the frame, wherein the third wheel rotates about a first vertical axis and the second wheel rotates about a second vertical axis.

6. The vehicle of claim 1, further comprising a third wheel coupled to the frame, wherein a vertical distance between the third wheel and the frame is fixed.

7. The vehicle of claim 1, further comprising a biasing element coupled to the subframe, wherein the biasing element is configured to bias the subframe to direct the first wheel toward a ground surface.

8. The vehicle of claim 7, wherein the biasing element is a gas spring.

9. The vehicle of claim 1, further comprising:
a mounting bracket coupled to the frame; and
a biasing element coupled between the mounting bracket and the subframe, wherein the biasing element includes a first swivel coupling coupled to the mounting bracket, the first swivel coupling enabling the biasing element to rotate relative to the mounting bracket.

10. The vehicle of claim 9, wherein the biasing element further includes:
a body extending from the first swivel coupling;
a rod extending from the body and configured to move relative to the body; and
a second swivel coupling coupled between the rod and the subframe, the second swivel coupling enabling the biasing element to rotate relative to the subframe.

11. The vehicle of claim 1, wherein the drive motor is a first drive motor, the vehicle includes a second drive motor configured to drive a fourth wheel to propel the vehicle, and the first wheel and the fourth wheel rotate independently.

12. The vehicle of claim 11, wherein the first wheel and the fourth wheel are configured to rotate in opposite directions to turn the frame about a substantially vertical axis.

13. The vehicle of claim 1, wherein the second wheel is configured to rotate about a first vertical axis in response to the first wheel being driven by the drive motor.

14. A drive arrangement for a vehicle, the drive arrangement comprising:
a first drive module including:
a first subframe pivotably coupled to a frame;
a first caster coupled to the first subframe;
a first drive wheel rotatably coupled to the first subframe; and
a first drive motor coupled to the first subframe and configured to drive the first drive wheel; and
a second drive module including:
a second subframe pivotably coupled to the frame;
a second caster coupled to the second subframe;
a second drive wheel rotatably coupled to the second subframe; and
a second drive motor coupled to the second subframe and configured to drive the second drive wheel.

15. The drive arrangement of claim 14, wherein the first drive wheel and the second drive wheel are configured to rotate in opposite directions to turn the frame about a substantially vertical axis.

16. The drive arrangement of claim 14, further including a third caster and a fourth caster coupled to the frame, wherein a vertical distance between the third caster and the frame is fixed, and the vertical distance between the fourth caster and the frame is fixed.

17. The drive arrangement of claim 14, further comprising a first bumper and a second bumper coupled to the frame, wherein the first subframe is configured to pivot relative to the frame about a first lateral axis defined between the first drive wheel and the first caster, the second subframe is configured to pivot relative to the frame about a second lateral axis defined between the second drive wheel and the second caster, and wherein the first bumper and the first caster are forward of the first lateral axis and the second bumper and the second caster are forward of the second lateral axis.

18. The drive arrangement of claim 14, wherein the first drive module further includes a first biasing element coupled to the first subframe, and wherein the first biasing element is configured to bias the first subframe to rotate about a first lateral axis to direct the first drive wheel toward a ground surface.

19. The drive arrangement of claim 14, wherein the second drive module further includes a second biasing element coupled to the second subframe, and wherein the second biasing element is configured to bias the second subframe to rotate about a second lateral axis to direct the second drive wheel toward a ground surface.

20. A vehicle comprising:
a frame;
a first drive module including:
a first subframe pivotably coupled to the frame;
a first caster coupled to the first subframe;
a first drive wheel rotatably coupled to the first subframe;
a first biasing element coupled to the first subframe and configured to bias the first subframe to rotate about a first lateral axis to direct the first drive wheel toward a ground surface; and
a first drive motor coupled to the first subframe and configured to drive the first drive wheel; and
a second drive module including:
a second subframe pivotably coupled to the frame;
a second caster coupled to the second subframe;
a second drive wheel rotatably coupled to the second subframe;
a second biasing element coupled to the second subframe and configured to bias the second subframe to rotate about a second lateral axis to direct the second drive wheel toward the ground surface; and
a second drive motor coupled to the second subframe and configured to drive the second drive wheel, wherein the first drive wheel and the second drive wheel are configured to rotate independently in opposite directions to turn the frame about a substantially vertical axis extending within an outer perimeter defined by the frame.
